(19) United States
(12) Patent Application Publication
(10) Pub. No.: US 2022/0194522 A1
(43) Pub. Date: Jun. 23, 2022

(54) FISHING HOOK PENETRATION GUARD FOR BOAT SURFACES

(71) Applicant: Sniper Marine, LLC, Maryville, TN (US)

(72) Inventors: Charlie Mac Helms, III, Vonore, TN (US); Timothy David Tipton, Maryville, TN (US)

(73) Assignee: Sniper Marine, LLC, Maryville, TN (US)

(21) Appl. No.: 17/559,660

(22) Filed: Dec. 22, 2021

Related U.S. Application Data
(60) Provisional application No. 63/130,337, filed on Dec. 23, 2020.

(51) Int. Cl. B63B 17/00; B32B 7/12; B32B 7/08; B32B 27/08; B32B 3/30

(52) U.S. Cl. CPC B63B 17/00; B32B 7/12; B32B 2605/12; B32B 27/08; B32B 3/30; B32B 7/08

(57) ABSTRACT

A protective mat for keeping fishing gear untangled with boat surfaces including a first layer including a hard upper surface and a second layer for engaging the protective mat with boat carpet.

### CROSS-REFERENCE TO RELATED APPLICATIONS

This application is a non-provisional application tracing priority and claiming benefit to U.S. Provisional Application No. 63/130,337, entitled “FISHING HOOK PENETRATION GUARD FOR BOAT SURFACES”, filed Dec. 23, 2020, the entirety of which is expressly incorporated herein by reference.

### FIELD

This disclosure relates to the field of fishing accessories and equipment. More particularly, this disclosure relates to a protective mat for use inside fishing boats for keeping fishing gear untangled with boat surfaces.

### BACKGROUND

Boats used for fishing such as, for example, bass fishing often have carpet-like surfaces or other loop-type surfaces (hereinafter, collectively, “boat carpet”). Common fishing gear includes one or more hooks that form part of a fishing rig. These rigs are stored on boats in specific areas while not in use and often come into contact with the boat carpet surfaces found on many boats in these areas. It is common for the hooks in fishing rigs to become entangled with boat carpet, making it difficult to disentangle the hooks from the boat carpet causing damage to carpet and risk of injury to detangler.

What is needed, therefore, is a means to protect fishing rig hooks and/or lures from boat carpet while such fishing rigs are stored on a boat.

### SUMMARY

The above and other needs are met by embodiments of the present invention, which are directed to a protective mat for keeping fishing gear untangled with boat surfaces including a first layer including a hard upper surface and a second layer for engaging the protective mat with boat carpet.

According to embodiments of the invention, a protective mat includes a first layer comprising a polymer-based material, the first layer comprising a first first layer surface and a second first layer surface; a second layer adhered to the second first layer surface and configured to physically engage with boat carpet.

In some embodiments, the protective mat also includes an adhesive layer for adhering the first layer to the second layer.

In some embodiments, the second layer comprises small hook fasteners for engagement with boat carpet.

In some embodiments, the second layer comprises a first second layer surface and a second second layer surface wherein the first second layer surface is adhered to the second first layer surface and wherein the second second layer surface comprises a plurality of spikes extending out from the second second layer surface. In some such embodiments, the first layer and the second layer are made of plastic.

According to embodiments of the invention, a protective mat for adherence to an interior boat surface includes (a) a first layer including a first surface and a second surface, (b) wherein the first layer is made of a polymer-based material and comprises a plurality of spikes extending out from the second surface.

In some embodiments, the protective mat also includes an adhesive layer for adhering the first layer to the second layer.

In some embodiments, the second layer comprises small hook fasteners for engagement with boat carpet.

In some embodiments, the second layer comprises a first second layer surface and a second second layer surface wherein the first second layer surface is adhered to the second first layer surface and wherein the second second layer surface comprises a plurality of spikes extending out from the second second layer surface. In some such embodiments, the first layer and the second layer are made of plastic.

According to embodiments of the invention, a protective mat for adherence to an interior boat surface includes (a) one or more magnets configured to secure one or more pieces of equipment to the protective mat, (b) wherein the protective mat is made of a polymer-based material.

In some embodiments, the protective mat also includes an adhesive layer for adhering the first layer to the second layer.

In some embodiments, the second layer comprises small hook fasteners for engagement with boat carpet.

In some embodiments, the second layer comprises a first second layer surface and a second second layer surface wherein the first second layer surface is adhered to the second first layer surface and wherein the second second layer surface comprises a plurality of spikes extending out from the second second layer surface. In some such embodiments, the first layer and the second layer are made of plastic.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 shows a protective mat according to embodiments of the invention;

FIG. 2 shows other embodiments of the protective mat;

FIG. 3 shows other embodiments of the protective mat;

FIG. 4 shows other embodiments of the protective mat;

FIG. 5 shows a protective mat system according to embodiments of the invention;

FIG. 6 shows other embodiments of a protective mat system;

FIG. 7 shows other embodiments of a protective mat; and

FIG. 8 shows an example of locations at which protective mats according to embodiments of the invention may be disposed in a boat.

The figures are provided to illustrate concepts of the invention disclosure and are not intended to embody all potential embodiments of the invention. Therefore, the figures are not intended to limit the scope of the invention disclosure in any way, a function which is reserved for the appended claims.

### DETAILED DESCRIPTION

A protective mat 100 for use in fishing boats is disclosed. Generally speaking, embodiments of the invention provide for a plastic, rubber, metal, or other material formed and shaped into specific sizes and shapes in order to be applied to a surface to protect from hook or other metal penetration. The protective mat 100 may use, in various embodiments, different methods for attachment to the surface, such as by hook and loop fastener system, sewing system, adhesive such as glue, screws, nails, pop-rivets or the like. A primary use-case of the invention is for fishing vessels that have an exposed penetrable surface such as carpeting on the floor of a fishing boat. Hooks can become caught in the vessel's carpeting, thereby causing damage to both lures and carpeting. Typically, to remove hooks caught in carpeting requires the angler to use hands or tools, running the risk of injury to the angler.

The protective mat 100 of the present invention stops or inhibits penetration and prevents damage. The protective mat 100 allows the angler to use time more efficiently, avoiding unnecessary waste of time removing hooks from carpeting and saves resources by prevention of damage to costly lures.

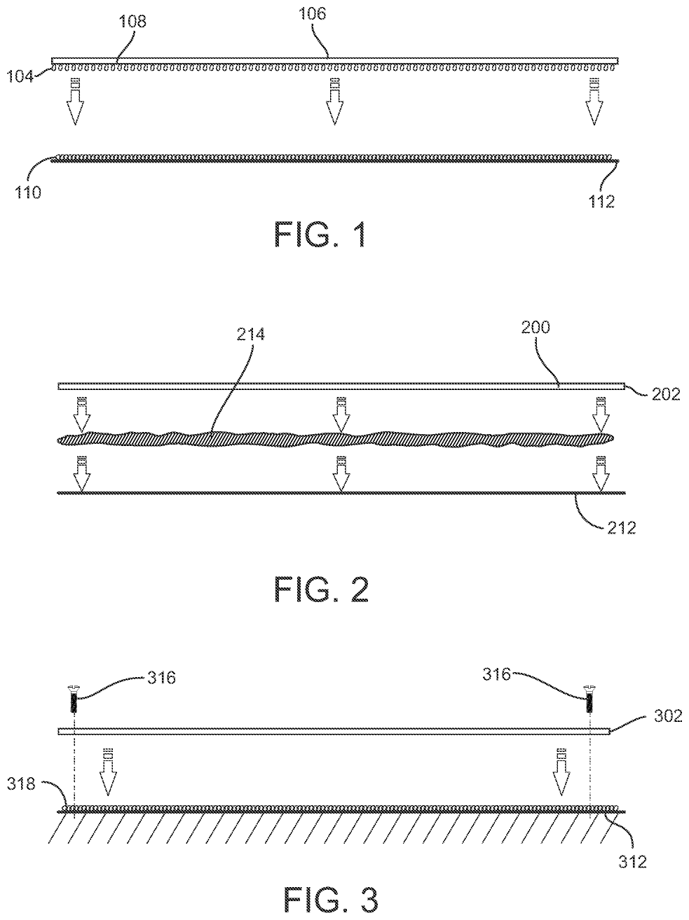

FIG. 1 shows a cross-sectional view of the protective mat 100 utilizing a hook-loop connection system for attachment of the protective mat 100 to the carpeted boat surface. The protective mat 100 can be cut into various shapes to fit different sized and shaped boat surfaces. When in use, the second layer 104 of the protective mat 100 is pressed against boat carpet to engage the protective mat 100 with the boat carpet. Fishing rigs including fishing hooks can then be stored against the first surface 106 of the first layer 102 without becoming entangled with the boat carpet beneath the protective mat 100.

Some embodiments of the invention provide that the protective mat 100 includes a first layer 102 attached to a second layer 104. The first layer 102 may be or include a hook non- penetration material and/or may include a first surface 106 that is hard in order to prevent fishing hooks from becoming engaged with or otherwise entangled with the first layer 102. The second layer 104 may be a layer including flexible hook-type fastener material 108 with tiny flexible hooks for engaging with a loop-type material 110. The loop-type material 110 may be or include carpeting disposed on a boat subfloor 112. In some embodiments, the loop-type material 110 is included on a third layer which is attached to the boat subfloor 112 and may include carpeting or be without carpeting. The carpeting may itself function as the loop-type material 110 for coupling with a hook-type fastener material 108. Accordingly, embodiments of the present invention may be utilized with a preexisting carpeted boat flooring without requiring removal of carpeting or other intrusive modifications to the boat flooring. An example of the flexible hook-type fastener material 108 includes the hook fastening material used with Velcro™ brand materials.

The first layer 102 may be made of a polymer-based material such as, for example, plastic. Specific examples include polyvinylchloride (PVC), polyethylene, and nylon. Other materials can be used other than polymer-based materials so long as the material can be adhered to the second layer 104 and so long as the material forms a hard outer surface. For example, the protective mat, including the first layer 102 may be made of metal, metal alloys, or a combination of polymers and metals.

The second layer 104 is preferably made of small flexible nylon hook-type material common with hook and loop fastening systems such as Velcro™. Other materials other than nylon can be used including, for example, polyester and polypropylene.

In some embodiments, as shown in FIG. 2, an adhesive layer 214 may be used to adhere the first layer 202 directly to the boat subfloor 212. Any adhesive known to persons having ordinary skill in the art can be used. Adhesive may also be used in embodiments utilizing hook- type fastener material 108 in order to adhere the hook-type material 108 or the loop-type material 110 to the underside of the first layer 202 and/or to adhere the corresponding loop-type material 110 or hook-type material 108 to the boat subfloor 212, where the boat subfloor 212 does not have a surface covering such as carpeting already attached. In embodiments of the invention, such as shown in FIG. 2, the protective mat 200 may be permanently or semi-permanently attached to the boat subfloor 212, whereas in the embodiment shown in FIG. 1, the protective mat 100 may be removably attached to the boat subfloor 112 and/or carpeting. Furthermore, the adhesive may be used to fasten the protective mat 200 directly to a carpeted surface of the boat floor.

Referring now to FIG. 3, another embodiment of the protective mat 300 is shown. In this embodiment, the protective mat 300 is attached to the boat subfloor 312 via one or more fasteners 316. In the embodiment shown, the fasteners 316 are screws, but in other embodiments the fasteners 316 may be or include a hook and loop fastener system such as discussed above, a sewing system, glue or other adhesive, nails, pop-rivets, or come combination of these. In such embodiments, the sub-floor may include a penetrable surface covering such as carpeting 318, may include no covering, or some combination.

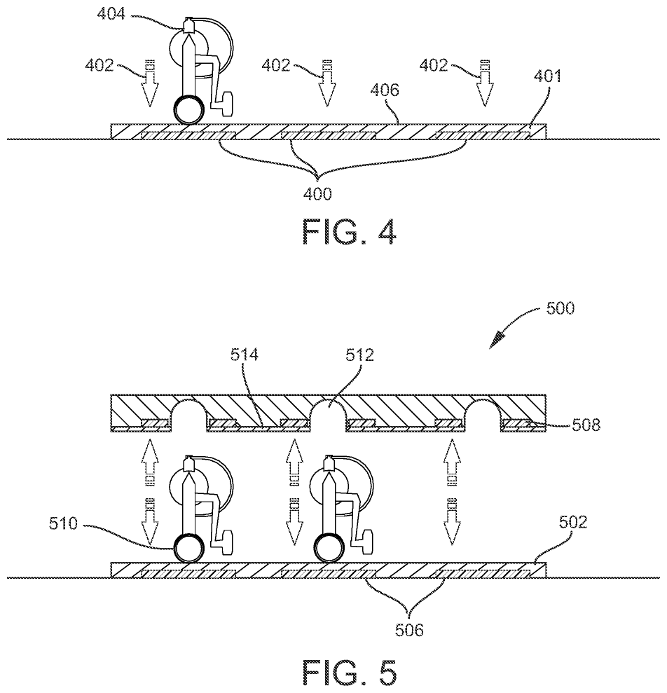

Referring now to FIG. 4, an alternate embodiment of the protective mat 401 is shown. Various embodiments of the protective mat 401, such as the one shown in FIG. 4, include one or more magnets 400, which may be part of a magnetic insert or fabric which maintains a magnetic field 402 for holding fishing rods or other metal objects 404 to the surface by magnetic force. The magnets 400 may be under, within, or on the upper surface 406 of the protective mat 400.

Referring now to FIG. 5, a magnetic protective mat system 500 is shown according to embodiments of the invention. As shown, in some embodiments, the system 500 may include a lower protective mat 502 and an upper protective mat 504 configured to removably couple with one another. In some embodiments, one or both the lower protective mat 502 and upper protective mat include one or more magnets 506, 508, respectively, for coupling the mats 502 and 504 with one another. The magnets 506, 508 may be under, within, or on the surfaces of the lower and upper protective mats 502, 504. The lower and/or upper protective mats 504, 506 may include one or more grooves cut into its lower surface for facilitating coupling and holding equipment, such as a fishing rod 510. The lower and/or upper protective mats 504, 506 may include padding 514 or other soft material such as foam in order to minimize or eliminate the possibility of damaging equipment such as a fishing rod.

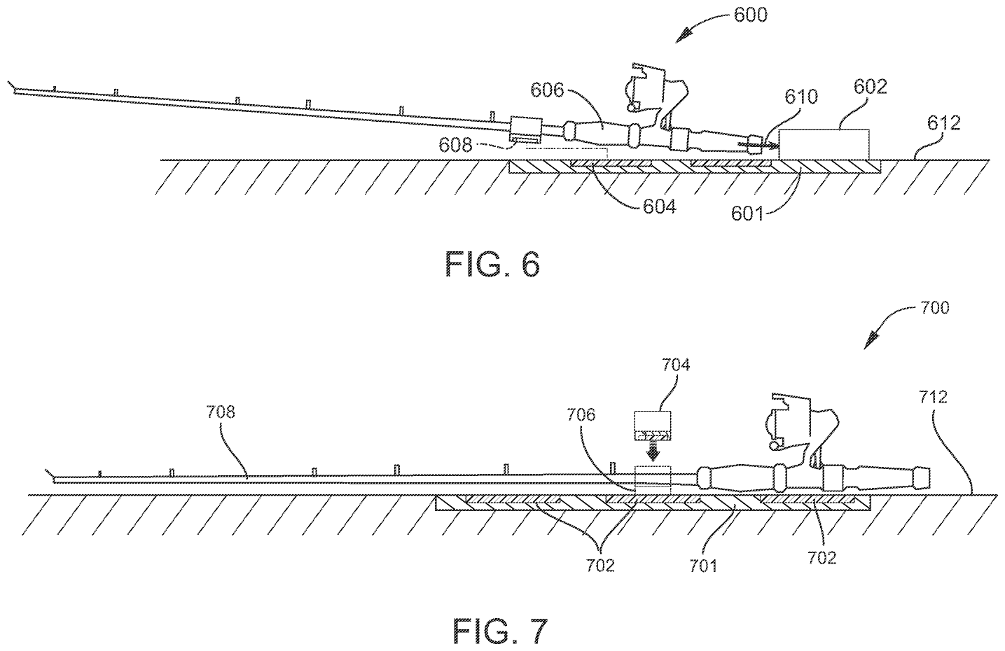

Referring now to FIG. 6, another embodiment of a protective mat system 600 is shown. The system 600 includes a protective mat 601 attached to the boat subfloor 612 or surface and a holster 602 attached to the protective mat 601. The holster may be a hollow cylindrical shape with an open end for receiving equipment such as a fishing rod 606 such as shown by arrow 610. In some embodiments, the protective mat 601 has one or more magnets 604 embedded or otherwise attached to the protective mat 601. The equipment, such as the fishing rod 606 may likewise include a corresponding one or more magnets 608 configured to couple with the magnet 604 of the protective mat 601 when the fishing rod 606 is stowed in the holster 602. In some embodiments, the magnet 608 on the equipment is part of a removable tag 614, which may be used temporarily on a piece of equipment, then removed and used on a different piece of equipment.

Referring now to FIG. 7, another embodiment of the a protective mat system 700 is shown. The system 700 includes a protective mat 701 attached to the boat subfloor 712 or surface and includes one or more magnets 702 embedded therein or other attached to the protective mat 701. A piece of equipment such as a fishing rod 708 has a tag 704 with one or more magnets 706 connected thereto. The tag 704, in various embodiments, may be removable or may be permanently installed on the fishing rod 708. The magnets 702, 706 are configured to couple with one another to hold the equipment in place against the protective mat 701.

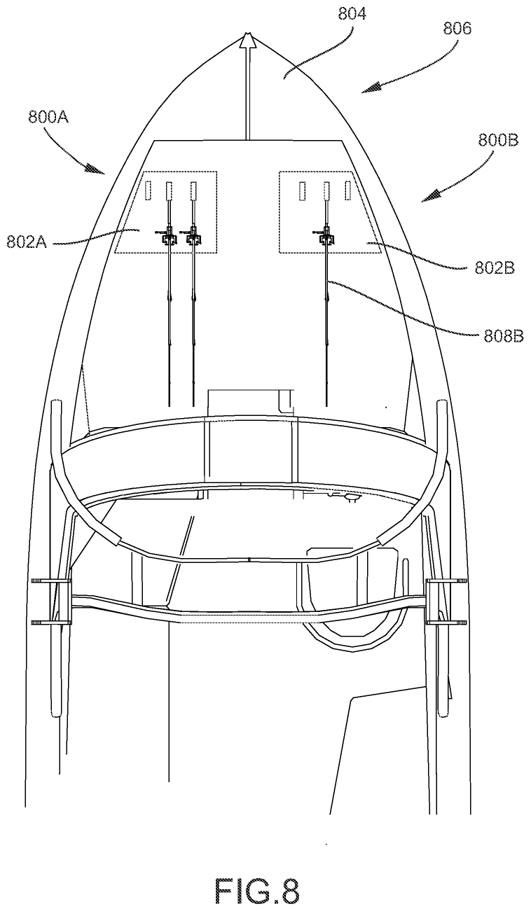

Referring now to FIG. 8, an illustration depicts possible locations 800A and 800B for protective mats 802A and 802B to be installed in a bow 804 of a boat 806 in order to secure equipment 808A and 808B.

In an alternative embodiment, a protective mat is disclosed including a first layer. The first layer includes a first surface that is hard. The protective mat further includes a plurality of spikes extending outward along or proximate to a second surface of the first layer. In some embodiments, the plurality of spikes are formed as a part of the first layer on the second surface of the first layer using polymer molding techniques known to persons having ordinary skill in the art. In other embodiments, the protective mat includes a second layer adhered to the second surface of the first layer wherein the second layer includes the plurality of spikes. An adhesive layer may be used to adhere the first layer to the second layer. Any adhesive known to persons having ordinary skill in the art can be used. The first layer may be made of a polymer-based material such as, for example, plastic. Specific examples include polyvinylchloride (PVC), polyethylene, and nylon. The second layer may also be made of these same materials, but other materials are contemplated including rubber and metal.

In various embodiments, the protective mats disclosed herein may be installed such that their upper surfaces are flush or nearly flush with the surface of the sub-floor or other hard flooring surface of the boat. In this regard, the flooring or sub-flooring of the boat may have a depression or other gap configured for receiving and coupling with the installed protective mat.
100 protective mat
102 first layer
104 second layer
106 first surface (of first layer)
108 flexible hook-type fastener material
110 loop-type material
112 boat subfloor
200 protective mat
202 first layer
212 boat subfloor
214 adhesive layer
300 protective mat
316 fasteners
318 carpeting
400 magnets
401 protective mat
402 magnetic field
404 metal object
406 upper surface
500 magnetic protective mat system
502 lower protective mat
504 upper protective mat
506 magnets
508 magnets
510 fishing rod
512 grooves
514 padding
600 protective mat system
601 protective mat
602 holster
604 mat magnet
606 fishing rod
608 rod magnet
610 arrow
612 boat subfloor
614 tag
700 protective mat system
701 protective mat
702 magnets
704 tag
706 tag magnets
708 fishing rod
712 boat subfloor
800A, B locations
802A, B protective mats
804 bow
806 boat
808A, B equipment

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

Any element in a claim that does not explicitly state “means for” performing a specified function, or “step for” performing a specific function, is not to be interpreted as a “means” or “step” clause as specified in 35 U.S.C. § 112, ¶ 6. In particular, the use of “step of” in the claims herein is not intended to invoke the provisions of 35 U.S.C. § 112, ¶ 6.

What is claimed is:

1. A protective mat for adherence to an interior boat surface, the protective mat comprising:
a. a first layer comprising a polymer-based material, the first layer comprising a first first layer surface and a second first layer surface;
b. a second layer adhered to the second first layer surface and configured to physically engage with boat carpet.

2. The protective mat of claim 1 further comprising an adhesive layer for adhering the first layer to the second layer.

3. The protective mat of claim 1 wherein the second layer comprises small hook fasteners for engagement with boat carpet.

4. The protective mat of claim 1 wherein the second layer comprises a first second layer surface and a second second layer surface wherein the first second layer surface is adhered to the second first layer surface and wherein the second second layer surface comprises a plurality of spikes extending out from the second second layer surface.

5. The protective mat of claim 4 wherein the first layer and the second layer are made of plastic.

6. A protective mat for adherence to an interior boat surface, the protective mat comprising:
(a) a first layer including a first surface and a second surface,
(b) wherein the first layer is made of a polymer-based material and comprises a plurality of spikes extending out from the second surface.

7. The protective mat of claim 6 further comprising an adhesive layer for adhering the first layer to the second layer.

8. The protective mat of claim 6 wherein the second layer comprises small hook fasteners for engagement with boat carpet.

9. The protective mat of claim 6 wherein the second layer comprises a first second layer surface and a second second layer surface wherein the first second layer surface is adhered to the second first layer surface and wherein the second second layer surface comprises a plurality of spikes extending out from the second second layer surface.

10. The protective mat of claim 8 wherein the first layer and the second layer are made of plastic.

11. A protective mat for adherence to an interior boat surface, the protective mat comprising:
(a) one or more magnets configured to secure one or more pieces of equipment to the protective mat,
(b) wherein the protective mat is made of a polymer-based material.

12. The protective mat of claim 11 further comprising an adhesive layer for adhering the first layer to the second layer.

13. The protective mat of claim 11 wherein the second layer comprises small hook fasteners for engagement with boat carpet.

14. The protective mat of claim 11 wherein the second layer comprises a first second layer surface and a second second layer surface wherein the first second layer surface is adhered to the second first layer surface and wherein the second second layer surface comprises a plurality of spikes extending out from the second second layer surface.

15. The protective mat of claim 13 wherein the first layer and the second layer are made of plastic.
